(19) United States
(12) Patent Application Publication
(10) Pub. No.: US 2021/0360875 A1
(43) Pub. Date: Nov. 25, 2021

(54) Grow With Me - Backyard Playland

(71) Applicant: Stephanie Ann Green, Milwaukie, OR (US)

(72) Inventor: Stephanie Ann Green, Milwaukie, OR (US)

(21) Appl. No.: 16/882,504

(22) Filed: May 24, 2020

(51) Int. Cl. A01G 9/28; A01G 22/15; A01G 20/00

(52) U.S. Cl. CPC A01G 9/28; A63H 3/36; A01G 20/00; A01G 22/15

(57) ABSTRACT

The present invention is new art with a new function and is comprised of box or container that is composed of grass, dirt, herbs and any and all toys to decorate the backyard. The intent is for kids to create their own real-life backyard by growing grass, cutting the grass, watering the grass, planting herbs and putting toys and items in the backyard to decorate as they see fit. This toy will help educate kids on becoming a gardener while teaching them responsibility.

### CROSS-REFERENCE TO RELATED APPLICATIONS

This section is non-applicable to this patent application.

### STATEMENT REGARDING FEDERALLY SPONSORED RESEARCH OR DEVELOPMENT (IF APPLICABLE)

There are no rights to this invention under federally sponsored research and development programs.

### JOINT RESEARCH AGREEMENT

This is not a joint research agreement and the only inventor is Stephanie Green.

### INCORPORATED BY REFERENCE OF MATERIAL

This section is non-applicable to this patent application as there is no material incorporated by reference.

### PRIOR DISCLOSURES BY INVENTOR

There are no prior disclosures by the inventor.

### BACKGROUND OF THE INVENTION

This is a new invention in which no patents or ideas already exist. The invention relates to the field of children's toys. This patent is for the development of a new kids toy whereby the user gets to plant grass and herbs in what looks like backyard and maintain the lawn and herbs. The user can also add items such as a miniature BBQ, Hot Tub, Sports Net, Chickens, Dogs, Cats, Dolls, Chairs, Tables and anything else the user wants. All types of grasses, herbs and backyard decorating toys as mentioned above are in scope of this patent.

There is no related art or information needed to be disclosed pursuant to 37 CFR 1.97 and 1.98 that is like this patent application. This invention is unique and through market research nothing similar was discovered. In addition, a prior USPTO search was conducted on www.uspto.gov and no similar patents were found.

### SUMMARY OF THE INVENTION

As mentioned above, there is a huge market and need for this product. The invention is considered a kids toy whereby kids can plant and grow their own backyard and also decorate the backyard with any item they wish.

### DESCRIPTION OF THE DRAWING

FIG. 01 is a view of what the toy looks like.

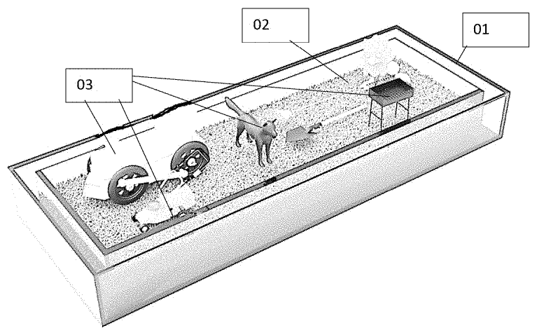

### DETAILED DESCRIPTION OF THE INVENTION

01=A box or container that holds the grass and backyard toys.
02=Grass (any type of grass and herbs can be used).
03=Any type of toy such as dogs, tables, chairs, dolls, hot tub, BBQ, lawn mower, watering can and any and all toys can be used with this toy.

1. A kids toy comprising of:
(a) a box or container that grass and herbs can grow in (any material is in scope and any size of container is in scope)
(b) Grass Seeds, Herbs and Toys are included which the intent is to fill the backyard with the aforementioned
(c) The toy also includes tools to keep the grass maintained (cut and watered)
